(19) United States
(12) Patent Application Publication
(10) Pub. No.: US 2015/0102977 A1
(43) Pub. Date: Apr. 16, 2015

(54) Antenna for an RFID tag reader

(71) Applicant: QINETIQ LIMIED, Hampshire (GB)

(72) Inventors: Matthew J. Lockyear, Exeter (GB); Ian Richard Hooper, Exeter (GB); Matthew Biginton, Thame (GB); Andrew Shaun Treen, Exeter (GB)

(21) Appl. No.: 14/397,001

(22) PCT Filed: Apr. 29, 2013
(86) PCT No.: PCT/GB2013/000184

§ 371 Date: Oct. 24, 2014

(30) Foreign Application Priority Data
May 1, 2012 (GB) 1207602.2
Oct. 10, 2012 (GB) 1218193.9

(51) Int. Cl. H01Q 1/22; H01Q 19/00

(52) U.S. Cl. CPC H01Q 1/2216; H01Q 19/005
USPC 343/893; 343/899

(57) ABSTRACT

Some embodiments are directed to an antenna for use in interrogating RFID tags in close proximity thereto. The antenna can include an active element configured to resonate at or close to a frequency required to read an RFID tag, the active element comprising a feed point; and a plurality of passive elements, each passive element being configured to resonate at or around a frequency corresponding to said frequency, the passive elements being arranged around the active element such that the passive elements electromagnetically couple to the active element when the active element is driven by a signal supplied through the feed point.

### TECHNICAL FIELD OF THE INVENTION

The invention relates to an antenna for a radio-frequency identification (RFID) tag reader, and in particular relates to an antenna that is capable of reliably reading a large number of RFID tags that are in close proximity to each other.

### BACKGROUND TO THE INVENTION

The use of radio-frequency identification (RFID) tags to identify and track objects, animals or people is increasing due to the falling cost of RFID tags and the equipment used to interrogate them, and the continued demand for Automatic Identification (AutoID) systems which can provide improvements in the management of logistics.

One particular use of RFID is in the identification and tracking of individual documents or document files in an office environment. In particular, it is desirable to be able to locate, in real-time, a document or file to a particular desk or bank of desks in an office. To this end, RFID tags are attached to the relevant documents or files, and antennas (that emit the required radio-frequency electromagnetic energy to power and therefore read the RFID tags) are located near to each desk or bank of desks to be monitored. The power emitted by these antennas is adjusted so that each antenna only detects tags within a limited distance. By the appropriate positioning of the antenna, discrete detection zones can be created which locate tagged objects within the monitored space. In one possible configuration the antennas are located above the relevant desk or bank of desks to provide the required resolution, and have an associated reader unit that provides the driving electrical signals and that receives the data from the read RFID tags.

However, it has been found that this arrangement is typically unable to reliably read RFID tags on documents or files arranged randomly (e.g. in random orientations) or stacked in a pile of documents or files. This is due to a number of factors including screening effects in densely packed tag arrays, polarisation sensitivity of the tag and antenna, detuning of the tags due to the presence of dielectric loads (e.g. people), and multi-path interference in the local environment. This can be mitigated to some extent by increasing the power levels emitted by the RFID equipment and introducing additional antennas however it has been found that it is difficult to ensure that the antenna arranged above the desk or bank of desks does not inadvertently read an RFID tag that is located outside of the desired read volume e.g. on a different desk in a different bank of desks, which impacts the accuracy of the asset location capability provided.

Another desirable use of RFID is in the identification of samples in a laboratory environment. Typically, blood or tissue samples from patients are held in a small glass or plastic vials, and a large number of these vials (e.g. around 100) may be placed in close proximity to each other in a tray (for example in a 10×10 array). This tray of vials can then be passed between a number of technicians in the laboratory who perform various tests on the samples. These vials usually have a unique identifier printed on them, for instance an alphanumeric code or a barcode, which means that each vial needs to be individually removed from the tray to be identified. Therefore, it would be useful to attach an RFID tag to each vial and to read all of the RFID tags in a single action without having to remove each vial from the tray.

A tag on a vial can be read if placed very close to an antenna's surface where higher power density and more complex field components are present. However, the area over which the tag can be read is limited to the close proximity of the radiating antenna. In addition, a conventional antenna generates limited field components in the direction perpendicular to the antenna surface and hence the tag must be correctly orientated and located to effect its identification. This situation is further complicated, and tag detection made even harder, when the vials are presented at the antenna in a close-packed array, such as on a tray. In this instance mutual screening of the tags in the dense array, the orientation of the tags relative to the antenna, and lossy, high dielectric contents in the sample vials detuning the tag antenna, combine to detrimental effect. This inability to identify vials over large surface areas limits both the accuracy and utility of the conventional RFID based solutions. Even when a handheld RFID tag reader is used to scan the tray of vials from multiple angles over a period of tens of seconds, it is often not possible to reliably read all of the RFID tags. Furthermore, with conventional RFID tag readers (handheld or otherwise) reading RFID tags on these vials when a large number of them are held loosely in a bag or container, or scattered randomly across a worktop, is often very difficult and time consuming which negates the use of RFID for companies who wish to cut down on processing times in identifying and tracking samples.

Therefore, there is a need for improved antennas for use with RFID tag readers that allow RFID tags to be reliably read when there are a large number of RFID tags in close proximity to each other, and that can read tagged items within a defined, localised surface area equating to the read volume around the antenna.

### SUMMARY OF THE INVENTION

Therefore, according to an aspect of the invention, there is provided an antenna for use in interrogating RFID tags in close proximity thereto, the antenna comprising:
an active element configured to resonate at or close to the frequency required to read an RFID tag, the active element comprising a feed point; and
a plurality of passive elements, each passive element being configured to resonate at or around a frequency corresponding to said frequency, the passive elements being arranged around the active element such that the passive elements electromagnetically couple to the active element when the active element is driven by a signal supplied through the feed point.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows an antenna according to the invention located on a desk;

FIG. 2 shows a conventional square patch antenna;

FIG. 3 shows an antenna according to a first embodiment of the invention;

FIG. 4 illustrates the effect of varying the spacing between patches in an antenna according to the invention;

FIG. 5 illustrates the effect of varying the spacing between patches and the ground plane in an antenna according to the invention;

FIG. 6 shows the time averaged electric field generated on a plane parallel to the antenna surface (xy plane) by the antenna according to the first embodiment of the invention when driven through a feed point on the active element;

FIG. 7 illustrates the variation in spacing for passive elements in an antenna according to the first embodiment of the invention;

FIG. 8 illustrates the rotation of a passive element in an antenna according to the first embodiment of the invention;

FIG. 9 is a cross-section through an antenna according to a second embodiment of the invention;

FIG. 10 shows the way in which an element of the antenna according to the invention can be skewed becoming asymmetric on comparison to a regular shape;

FIG. 11 shows a number of antennas according to a third embodiment of the invention having elements with different degrees of skew;

FIG. 12 shows the instantaneous electric fields at several instants of time generated between the patches and the ground plane on a plane (xy) that is parallel to the ground plane, for an antenna according to the third embodiment;

FIG. 13 shows an alternative antenna according to the third embodiment of the invention;

FIG. 14 is a cross-section through an antenna according to a fourth embodiment of the invention;

FIG. 15 is a cross-section through an antenna according to a fifth embodiment of the invention;

FIG. 16 is a cross-section through an antenna according to a sixth embodiment of the invention;

FIG. 17 shows the construction of an antenna for use on a rectangular work space;

FIG. 18 shows ways in which larger antennas according to the invention can be driven;

FIG. 19 shows how two antennas according to the invention can be connected together to form a modular system; and

FIG. 20 illustrates an alternative way of driving an antenna according to the invention.

### DETAILED DESCRIPTION OF THE PREFERRED EMBODIMENTS

Although the invention will be described below with reference to an antenna for RFID tags that operate at a frequency generally in the range of 850 MHz to 1 GHz (and particularly at a frequency of 866 MHz), it will be appreciated by those skilled in the art that the antenna according to the invention described herein can be readily adapted for use at frequencies outside this band and for applications other than UHF RFID that require similar antenna performance characteristics

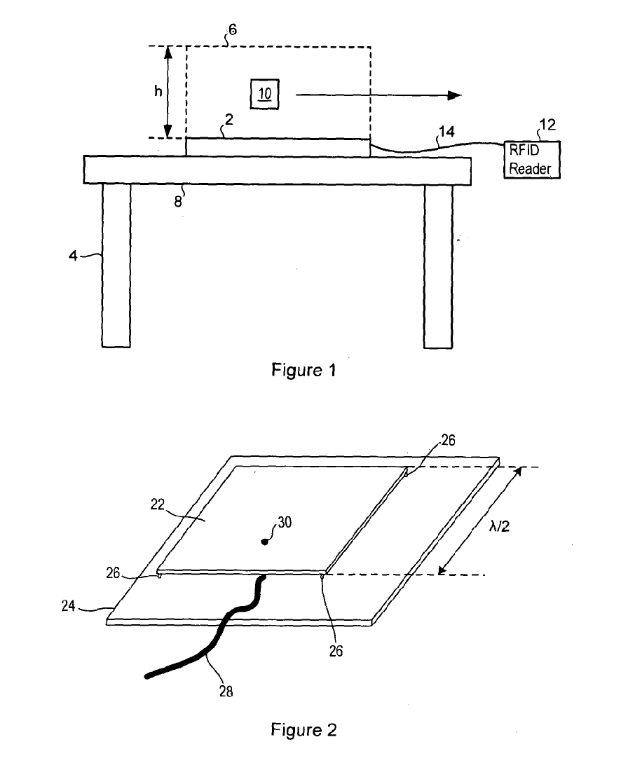

An antenna 2 according to the invention for use in reading RFID tags in proximity to a desk 4 is shown in FIG. 1. In the figure, the antenna 2 is placed on the work surface 8 of the desk 4, although it will be appreciated that the antenna 2 can alternatively be placed beneath the work surface 8 or integrated directly into the work surface 8.

The antenna 2 according to the invention is intended for use with tagged objects 10 in close proximity to the antenna surface. This region is generally termed the near field but it will be appreciated that the definition of where the near-field ends and far-field begins is somewhat vague. For the purpose of this discussion this region above the antenna 2 where the tags are to be identified will be termed the ‘read volume’ 6 the extent of which is indicated by the dimension h. h<0.8 m for the specific RFID application described herein. It will also be appreciated that although the antenna 2 is designed ideally to maximise all field components close to the antenna surface and the transitional regions within the read volume 6 it does not imply that there are no far-field components at a distance (e.g. 5-10 times the read volume 6 indicated by h).

The antenna 2 is connected to an RFID tag reader unit 12 via an electrical connection 14, such as coaxial cable, that provides the driving signal for the antenna 2 and that receives the information (such as a unique ID number) read from RFID tags.

In order to provide an antenna that can reliably read RFID tags when they are presented in close proximity to one another, for example a close packed array, the antenna 2 according to the invention preferably generates electric field components in the proximity of the antenna surface, and a defined ‘read volume’ in front of the antenna, which are dynamic and present with sufficient field strength and polarisation at each location to energise and communicate with an RFID tag placed in this volume in any arbitrary orientation. The field generated in the read volume 6 is not necessarily circularly nor elliptically polarised in the conventional sense of a propagating wave, but the field components generated will incorporate functional aspects of such propagation i.e. periodically rotating field components (chiral properties). For convenience the field and polarisation behaviour in the read volume 6 of the antenna 2 will be described as ‘entangled’ or ‘turbulent’, indicating the complex field profiles that are generated by the invention described herein. The field minima close to the antenna 2 usually associated with linearly polarised antenna are minimised producing a somewhat even distribution of electric and magnetic fields. However it will be appreciated that this does not necessarily mean that the field is the same strength at each point, but merely that the time-averaged field strength at each point in the field is sufficient to allow an RFID tag to be read.

As described in more detail below, this turbulent field pattern is provided by an antenna 2 that comprises an active patch antenna element that has one or more passive patch antenna elements arranged around the active element so that they capacitively couple to the active element when the active element is driven at, or near, its resonant frequency by a source of electromagnetic power, such as an RFID reader module.

For completeness, FIG. 2 shows a conventional patch antenna that produces linear polarisation 20 that forms the basis of the antenna 2 according to the invention. The patch antenna 20 comprises a generally square radiating element 22 mounted over a ground plane 24. The radiating element 22 and ground plane 24 are typically made of metallic sheet. Provided the metallic sheet is thicker than the metal skin depth, then it can be considered as a Perfect Electrical Conductor (PEC) for design purposes. In practice, thin metal foils with a thickness greater than a few microns can be used for Radio Frequency (RF) applications. A dielectric material can be used to separate the radiating element 22 from the ground plane 24, although in FIG. 2 supports 26 separate the radiating element 22 from the ground plane 24 leaving an air gap there between. Typically the dielectric spacer would be selected to have a low dielectric loss such that the minimum amount of RF power is lost through heating in the spacer material. The radiating element 22 is driven with an electrical signal supplied via an electrical connection 28 at a feed point 30 in the radiating element 22. Where the electrical connection 28 comprises a coaxial cable, the inner core of the cable is connected to the feed point 30 and the conducting sheath of the coaxial cable is connected to the ground plane 24.

The dimensions of the radiating element 22 generally determine the frequency at which the patch antenna 20 resonates, with the length of a side of the square radiating element being approximately equal to one-half of the wavelength inside the cavity formed between the patches and ground plane of the emitted radiation (so the resonant frequency is approximately c/2 nL where c is the speed of light, n is the refractive index of the dielectric spacer and L is the length of the side of the square radiating element 22). As is known, a symmetric patch antenna 20 driven at a single feed point 30 on a line of symmetry through the radiating element will primarily emit propagating, linearly polarised electromagnetic power into the far-field.

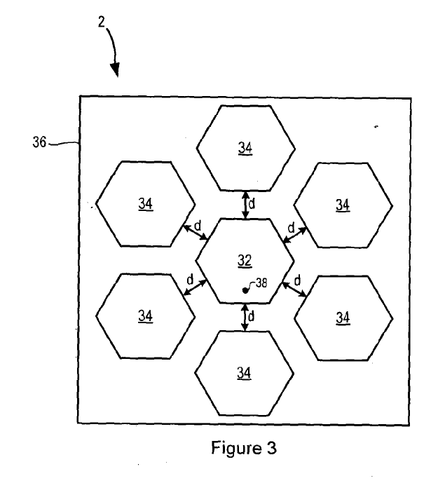

FIG. 3 shows a first embodiment of an antenna 2 according to the invention. The antenna 2 comprises a first patch antenna element 32 that has six other patch antenna elements 34 arranged in a plane around the first patch antenna element 32. The elements 32, 34 are also arranged above a ground plane 36. The first patch element 32, which is at the centre of the other patch antenna elements 34, is to be driven by an electrical signal from the reader unit 12 through at least one feed point 38. Therefore, it will be appreciated that there will be an electrical connection 14 (such as coaxial cable or any other suitable type of feed line) between the feed point 38 in antenna 2 and the reader unit 12, although this is not shown in FIG. 3.

The other (passive) patch elements 34 are arranged so that they are not in direct electrical contact with the first (active or driven) patch element 32, but they are arranged sufficiently close to the active patch element 32 that they act as coupled oscillators and alter the field intensity profile and frequency response of the electric field generated by the antenna 2 in the read volume 6 close to the antenna surface.

In the illustrated embodiment, each element 32, 34 of the antenna 2 is a regular hexagon and the elements 32, 34 are arranged in a hexagonal lattice pattern with spacing d between each of the passive elements 34 and the active element 32. The exact spacing d between the elements 32, 34 determines the degree to which the passive elements 34 couple to the active element 32, and thus the electric field generated across the antenna surface and into the read volume 6.

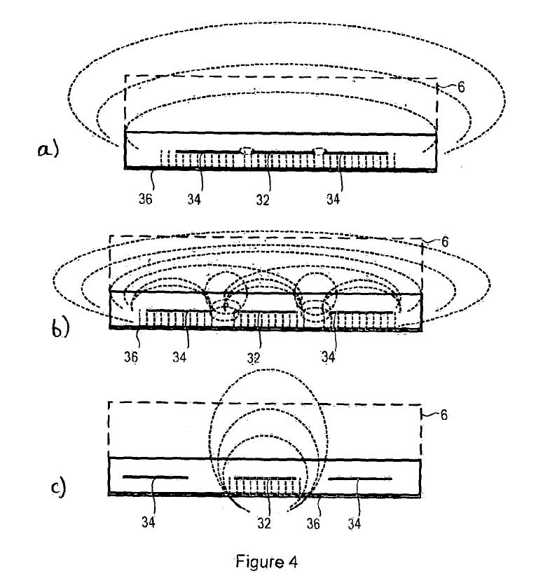

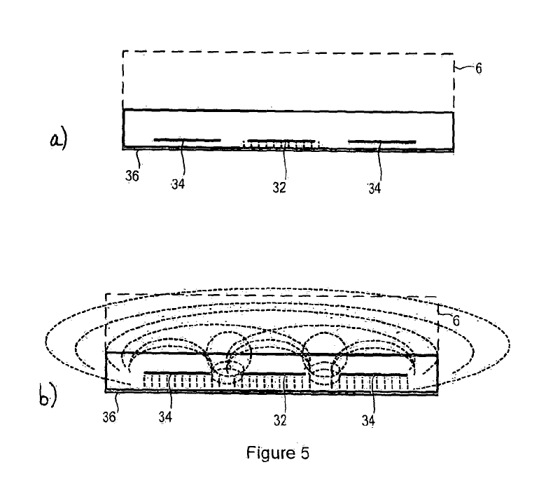

As shown in FIG. 4(a), if the passive elements 34 are too close to the active element 32 (d is too small), the capacitive coupling between the elements 32, 34 is too strong and the driven element 32 and the passive elements 34 act as a single individual resonator. This combined resonator is larger than the original driven element 32. In the case of equally sized elements then the combined resonator is approximately 2-3 times the dimension of the original active element 32, and hence will have a substantially modified field profile and hence antenna functionality. In addition the feed point 38 for this combined resonator (the array of patches) will not be optimised to energise the larger element reducing the power coupled to the active element 32 from the coaxial cable. This has the effect of reducing the non-propagating power available close to the antenna 2 and provides the possibility for tags to be detected in the far-field outside the read volume 6. In addition, the closely coupled elements do not generate the required complex field profiles, especially in the z-component perpendicular to the plane of the antenna 2, in the vicinity of the antenna surface which are beneficial for tag detection.

On the other hand, as shown in FIG. 4(c), if the passive elements 34 are too far from the active element 32 (d is too large), the coupling between the elements 32, 34 is weak. In this case the secondary elements 34 will be weakly energised, the active element 32 will effectively act as an isolated element on the surface, and the fields will be confined to the close proximity of this active element 32. This leads to limited lateral extent to the RFID detection, being localised to the active antenna area as described above. It has been found that a spacing d that is greater than around one quarter of the free-space wavelength of the radiation to be emitted results in the coupling of the elements to be too weak and the passive elements 34 not being strongly electromagnetically coupled. Furthermore, the extent of the electric field in the x and y directions (i.e. in the plane of the antenna 2) is determined by the extent of the elements 32, 34 in those directions. Thus, the spacing d between the active element 32 and passive elements 34 and the size of these elements will be selected to achieve the required read volume height and width. FIG. 4(b) illustrates the effect achieved when d is selected appropriately.

In the illustrated embodiment, each of the elements 32, 34 are the same size and are each configured to resonate generally at or close to the frequency required to read an RFID tag. Thus, for an RFID tag having a read frequency of 866 MHz, each of the hexagonal elements 32, 34 have a radius (i.e. the distance between the centre of the hexagon and each vertex) of approximately 0.097 m which results in a fundamental patch resonance close to the frequency of the array of elements. However, it will be appreciated that, given the complex electric fields generated by the antenna 2, the elements 32, 34 can vary from the desired size for a particular frequency by up to 10% and still allow RFID tags to be read inside the volume 6.

The spacing d between the elements 32, 34 is preferably between 1 mm to 8.8 cm for a frequency of 866 MHz and it is appreciated that these spacings would be modified for higher or lower operating frequencies. As described earlier, in reference to a conventional patch antenna, the dimensions of the active element 32 determine its fundamental resonance, i.e. the frequency of the driven signal at which it naturally resonates. The addition of secondary resonators 34 around the active element 32 changes its resonant behaviour. In general the fundamental resonance reduces in frequency and additional secondary modes are introduced. Thus the size of the elements 32, 34 in the antenna 2 are selected such that their natural eigenmode resonance is above the desired operating frequency such that, when combined in the array, the resonance of the system is tuned closer to the operating frequency.

The spacing of the radiating elements 32, 34 from the antenna ground plane 36 also affects the field patterns generated in the read volume 6. If the spacing, t, is too small (as shown in FIG. 5(a)), then the fields are largely confined below the resonant patch 32, 34 and have limited strength above the antenna 2. This provides poor tag reading capability in the read volume 6. As the thickness, t, is increased, an optimum distance will be achieved (as shown in FIG. 5(b)) where the fields in the read volume 6 are maximised yet limited power is emitted into the far-field. The preferred spacing for the RFID tag reading embodiment is at or around 1.2 cm, but the spacing t could be as small as 4 mm and as large as 3 cm. Again it will be appreciated that these dimensions will scale when operating at frequencies different from 866 MHz.

Hexagonal elements are generally preferred as they allow the elements 32, 34 to be arranged or tiled in an efficient manner (e.g. in a hexagonal lattice), and it provides six parallel sides through which capacitive coupling between the active element 32 and passive elements 34 can occur. In the embodiment illustrated in FIG. 3, the elements 32, 34 are regular hexagons. However, it will be appreciated by those skilled in the art that antennas according to this embodiment of the invention can be constructed by using elements 32, 34 having any shape, including circles, ellipses, other non-polygonal shapes, alternative regular polygons (for example triangles, squares, octagons, pentagons, etc.) and/or non-hexagonal lattice structures, and/or combinations of different types of shapes (i.e. hexagonal elements and non-hexagonal elements).

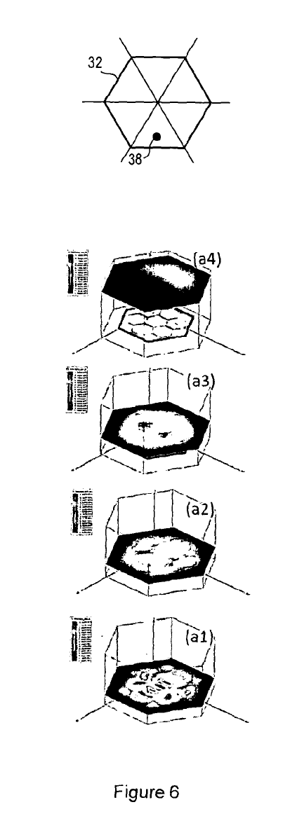

FIG. 6 illustrates the time-averaged field components of the electric field generated at different heights above the antenna 2 shown in FIG. 3. These plots are based on an antenna 2 with elements 32, 34 having a radius of approximately 0.097 m with the spacing d between the elements 32, 34 being 0.008 m. The elements 32, 34 are 0.001 m thick and are located 0.01 m above the ground plane 36. The active element 32 is driven at 866 MHz with a total power of 2 Wafts through the feed point 38.

For a particular antenna configuration of the nature described above there will be an optimised feed position 38 on the active element 32. In positioning the feed point 38 it is important to ensure that maximum power is coupled from the coaxial feed line into the patch 32. In this way the maximum power is available at the active patch 32 and hence available to be distributed to the other secondary elements 34 in the antenna 2 as a whole. The positioning of the feed point 38 on the active element 32 is also important in determining the degree of entanglement created in the antenna power distribution. Preferably the feed point 38 should be positioned asymmetrically on the active element 32.

In FIG. 6, the active patch 32 is driven via a single feed point 38. This results in the array of elements 32, 34 producing far field components that are predominantly linearly polarised, but the electric field couples to the passive elements 34 to produce a turbulent field in the read volume 6. It can be seen in FIGS. 6(a1) to 6(a4), which show the field at a height of 0.02 metres, 0.05 metres, 0.09 metres and 0.38 metres respectively, that the field produced is quite uneven, with some nulls in the time-averaged electric field away from the surface of the elements 32, 34. More of the power in the driving signal tends to couple to the elements 34 that are closest to the feed point 38 on the active element 32. Electric fields in the read volume have a component parallel to the antenna surface (i.e. x) that dominates over the other parallel component (i.e. y). This results in an increased sensitivity to the orientation of RFID tags. Further to this, a preferential coupling to passive patches 34 closer to areas of high electric fields under the driven patch 32 results in a non-uniform field distribution in the read volume 6.

Although the field produced using an antenna 2 with a single feed point 38 is an improvement over that obtained with conventional antennas, it is preferable for the field produced to be more even, and for the field to have a complex turbulent state in the read volume 6.

As mentioned above, the configuration of the field generated by the antenna 2 (including the position and strength of any minima), will depend on the exact spacing of the passive elements 34 from the active element 32. In the embodiment described above, the passive elements 34 are all spaced the same distance d from the active element 32. However, it is advantageous for the spacing d between the passive elements 34 and active element 32 to vary between passive elements 34 as this can increase the complexity of the fields in the read volume 6 by breaking symmetry lines in the lattice on which the driven element 32 and passive elements 34 reside, improving the ability of the field generated by the antenna 2 to read densely packed RFID tags placed in the read volume 6. By careful placement of passive patches 34 relative to one another and the driven patch 32 in an asymmetric, skewed, offset, rotated and/or random manner as described in more detail below, and/or using patches with non-symmetric shapes, it is possible to break symmetry planes and encourage more field components and non-linearity in comparison to a symmetric system. This break in symmetry in the elements 32, 34 provides more field components than a completely symmetric arrangement of elements and allows for both coupling to adjacent patches and an extension of the fields into the read volume 6. Thus, the passive elements 34 can have different spacings d from the active element 32 to each other. This means that the passive elements 34 will not be centred on their respective regular lattice points. In some cases, this spacing variation can be based on where the feed point 38 is located on the active element 32.

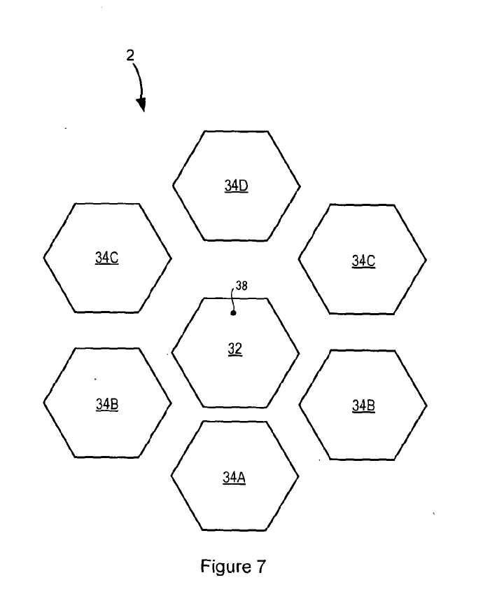

FIG. 6 shows that more power couples to the passive element 34 closest to the feed point 38 than to the other passive elements 34. Therefore, as shown in FIG. 7, in some embodiments the passive element 34 that would be positioned closest to the feed point 38 in a regular array (passive element 34D), can be spaced further from the active element 32 than any of the other passive elements 34. The passive element 34 that is furthest from the feed point 38 in a regular array (element 34A) will be arranged closer to the active element 32 than any other passive element 34. The adjustment of the relative spacings of the passive elements 34 in this way can help to improve the uniformity of the fields (i.e. reduce the presence of nulls) produced in the read volume 6.

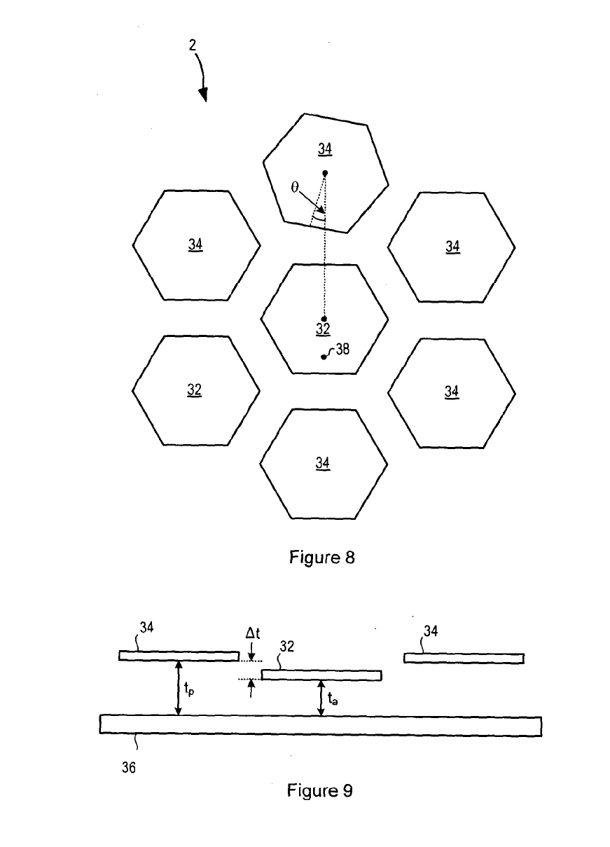

Another way to adjust the electric field produced by the antenna 2 to reduce the presence of field minima is to position one or more of the passive elements 34 so that their orientation is rotated with respect to the active element 32, as shown in FIG. 8. The coupling between the active element 32 and a passive element 34 is optimum when a side of the passive element 34 is directly facing and parallel with a side of the active element 32. Thus, rotating a passive element 34 by a small angle 8 about an axis that is perpendicular to the plane of the element 34 so that the side facing the active element 32 is not parallel with the side of the active element 32 reduces the coupling of power to the passive element 34, and thus changes the electric field produced above the passive element 34. Therefore, suitable adjustment of the orientation of the one or more passive elements 34 in the antenna 2 can help to reduce the minima present in the generated electric field. 8 is preferably less than 30°, since such rotation represents a fine tuning of the antenna 2.

As described above it is desirable to provide an asymmetric antenna 2 in order to maximise the fields within the read volume 6, and element separation, d, affects these fields. A further approach to creating asymmetry can be to locate the passive elements 34 at different spacings (t) to the ground plane 36 compared to the active patch element 32. This is illustrated in FIG. 9 in which the active element 32 is spaced a distance tₐ from the ground plane 36 and the passive elements 34 are spaced a distance tₚ from the ground plane 36, with tₐ≠tₚ. In FIG. 9, tₐ<tₚ, but alternatively it is possible for tₐ>tₚ. Thus the passive elements 34 can be either above or below (Δt less than or greater than) the active element 32 such that a spacing between the elements 32, 34 is introduced in the z-direction. In other words, the active element 32 is located in a different plane to the passive elements 34. This enhances the x y and z field components in the read volume 6. It is noted that bringing the driven patch 32 closer to the ground plane 36 than the passive patches 34 may result in increased coupling to adjacent patches 34, and the read volume 6 extending over a larger area of the antenna 2. It will also be appreciated that one or more of the passive elements 34 can be spaced a different distance from the ground plane 38 to the other passive elements 34 and/or active element 32.

As with the first embodiment described above, the positions and/or orientations of the passive elements 34 can be adjusted relative to that found in a regular hexagonal lattice in order to produce a time-average electric field distribution that is as uniform as possible (i.e. in which field minima are reduced). Also as with the first embodiment described above, hexagonal elements are generally preferred as they allow for effective coupling to all the passive elements 34 in comparison to a square array for example, although alternative regular (e.g. hexagons, octagons, pentagons, etc.) polygons, non-polygons (e.g. circles, ellipses, shapes incorporating one or more curved edges, etc.) and/or non-hexagonal lattice structures, and/or combinations of different types of polygon (i.e. hexagonal elements and non-hexagonal elements) can be used.

In a second embodiment according to the invention, an antenna 2 is provided that has one or more elements 32, 34 that are irregular (preferably asymmetric) polygons. The use of elements 32, 34 that are irregular polygons is advantageous because they produce turbulent fields in the read volume 6, and with a suitable spacing d or configuration of spacings d between the passive elements 34 and active element 32, a highly uniform time-averaged read field can be produced by the antenna 2. In some implementations of the second embodiment, each of the elements 32, 34 can be irregular shapes, although in other implementations, the antenna 2 can comprise a combination of regular and irregular elements 32, 34. For example, the active element 32 can be a regular polygon, and the passive elements 34 can be irregular polygons.

As with the first embodiment described above, the elements 32, 34 are preferably hexagonal in antennas 2 according to the second embodiment, but it will be appreciated that other shapes, or combinations of shapes, can be used.

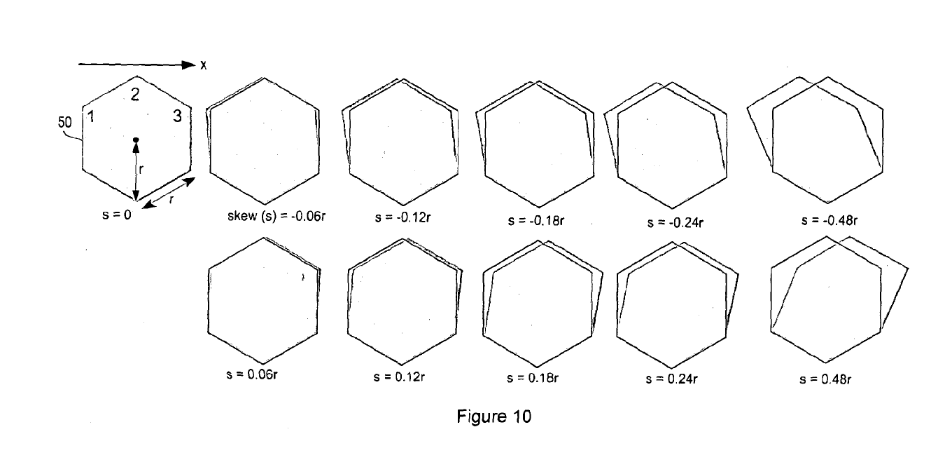

FIG. 10 illustrates a set of preferred asymmetric hexagons for use in antennas 2 according to the second embodiment. These elements 32, 34 are ‘skewed’ from a regular hexagon shape by shifting three neighbouring vertices of a regular hexagon horizontally relative to the other three vertices of the hexagon. The degree of skew, s (i.e. deviation from a regular hexagon shape) is given as a percentage, and the deviation in position of a shifted vertex from its position in a regular hexagon is given by s×r, where r is the length of a side in the regular hexagon (or the distance from the centre of the hexagon to the vertex). FIG. 10 shows ten examples of skewed hexagons, with positive and negative skews of 6%, 12%, 18%, 24% and 48% (positive skews are defined as movement of the neighbouring vertices to in the positive x-direction, and negative skews are defined as movement in the negative x-direction). Those skilled in the art will appreciate that other regular polygonal shapes can be skewed or generally made asymmetric in a similar way.

It has been found that skewing a regular element 32, 34 as shown in FIG. 10 breaks a degeneracy of the element 32, 34 and results in turbulent fields in the read volume 6 when driven at a single feed point 38.

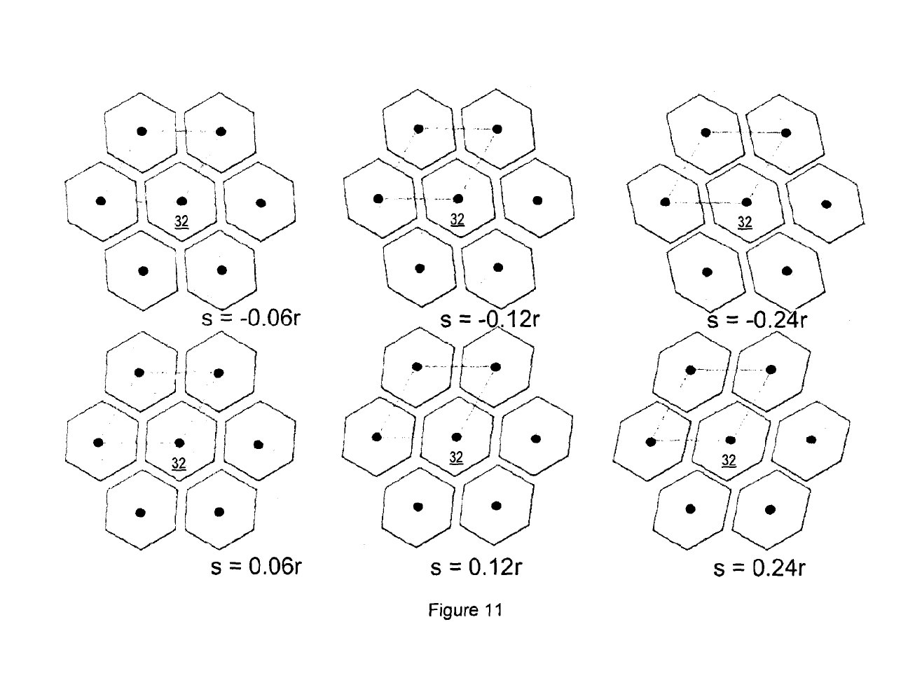

FIG. 11 shows six exemplary antennas 2 according to the second embodiment of the invention. The six antennas 2 have different degrees of skew, and the skewing of the hexagons results in a corresponding skewing of the hexagonal lattice around which the elements 32, 34 are arranged (the hexagonal lattice points are represented by the dots in the middle of each element 32, 34). It can be seen that, particularly in the implementations with a significant skew (e.g. s=0.24), skewing results in the coupling face of some of the passive elements 34 being slightly out of alignment with the corresponding face of the active element 32. The skewing of the lattice also results in there being different spacings d between the passive elements 34 and active element 32. However, it will be appreciated that, as in the first embodiment described above, the passive elements 34 (and/or the active element 32) can be offset from their lattice points to adjust the coupling between the elements and therefore the field produced by the antenna 2.

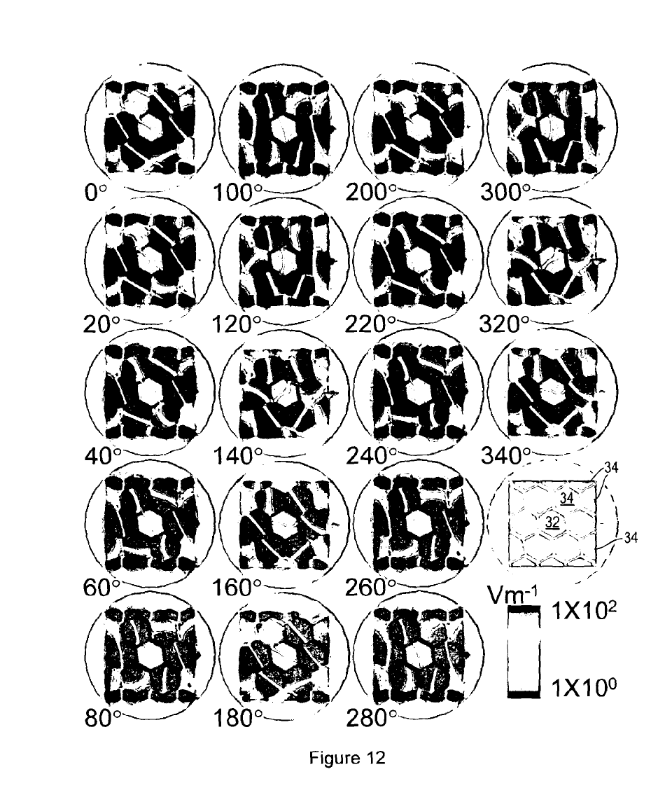

FIG. 12 shows an example of the instantaneous electric fields on a plane parallel to, and between the ground plane 36 and patch elements 32, 34 at various times in a frequency cycle for an antenna 2 comprising identically skewed hexagonal elements in a hexagonal array 32, 34 and that is driven at a feed point 38 on the active element 32. It has been found that completing the antenna 2 to the edge of the ground plane 36 may be advantageous, in which case the antenna 2 may comprise non-complete shapes. Thus, it will be noted that the antenna 2 used to generate the fields shown in FIG. 12 is square in shape and therefore comprises some additional (incomplete) passive elements 34 arranged around the outside of the first layer or ring of passive elements 34 in order to provide a square arrangement.

It can be seen from the field plots in FIG. 12 that the electric field antinodes (maxima) associated with the mode under the patches 32, 34 rotate throughout a frequency cycle, and the time-averaged field, even around the outer passive elements 34, is quite uniform and will allow RFID tags to be reliably read in the read volume 6 above the antenna surface. It has been found that the degree of skew of the elements 32, 34 affects the speed of precession of the field rotation.

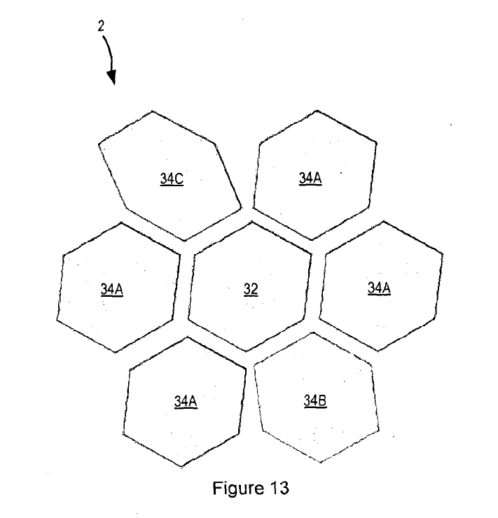

FIG. 13 shows another antenna 2 according to the second embodiment of the invention, illustrating ways in which the chiral fields produced can be modified to achieve the desired field profile. In this implementation, the active element 32 and passive elements 34A are skewed by a first amount, s1, passive element 34B is also skewed by amount s1 but has been rotated 60° in an anticlockwise direction about its lattice point, and passive element 34C has been skewed by an amount s1 in the opposite direction. Varying the direction of skew can encourage regions where coupling is less efficient to the other elements 32, 34. Varying the amount of skew between different elements 32, 34 can help to encourage a good overall degree of turbulent field components in certain points of the read volume 6. As indicated above, rotating an element 32, 34 about a lattice point can alter the profile of the field generated by the antenna 2, and can also provide convenient points to attach a wire connection with an appropriate length for driving multiple antennas 2, as described in more detail below.

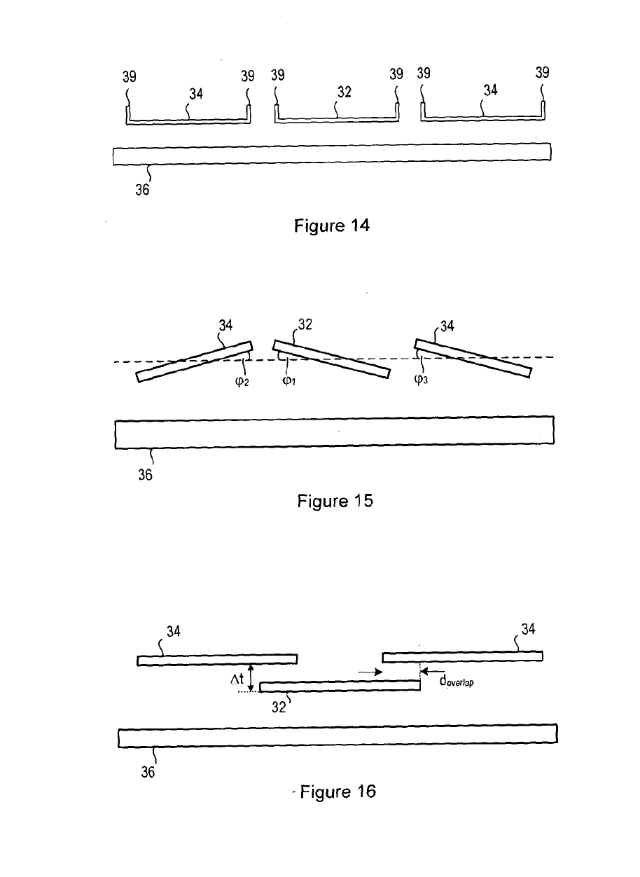

FIG. 14 is a cross-section through an antenna 2 according to a fourth embodiment of the invention. In this embodiment, rather than each of the active element 32 and passive elements 34 being planar, the elements 32, 34 each have an edge or lip portion 39 that extends substantially perpendicularly from the plane of the rest of the antenna element 32, 34. When the elements 32, 34 are arranged in a lattice pattern, the lips 39 face each other and result in improved coupling from the active element 32 to the passive elements 34 due to the increase in the surface area of the elements 32, 34 in close proximity to each other. It will be appreciated that the lip 39 can extend in either or both directions (e.g. upwards and/or downwards) from the plane of the antenna element 32, 34. The part of each element 32, 34 that lies in a plane parallel to the ground plane 36 can have generally the same area as for an element 32, 34 that does not have lip portions 39, provided the lip portions 39 do not form a significant fraction (e.g. they are less than 5%) of the size of the element 32, 34. This embodiment also has the advantage that the overall size of the antenna 2 can be reduced as the diameter of each of the elements 32, 34 will be less than in the first embodiment described above.

FIG. 15 is a cross-section through an antenna according to a fifth embodiment of the invention. In this embodiment, one or more of the active element 32 and passive elements 34 are positioned so that they do not lie parallel to the ground plane 36 of the antenna 2 and/or parallel to each other. This adjustment in element 32, 34 positioning helps to break up the field symmetry and produce the turbulent field components required to read multiple RFID tags in the read volume 6. In FIG. 15, each of the elements 32, 34 are shown as being rotated around an axis lying the plane of each of the elements 32, 34 with respect to the plane of the antenna 2 (as represented by the ground plane 36) by a respective angle cp. It will be appreciated that the elements 32, 34 can be rotated by the same or different amounts (and in different directions as shown in FIG. 15 by the left-hand passive element 34 being rotated in a different direction to the active element 32 and the right-hand passive element 34).

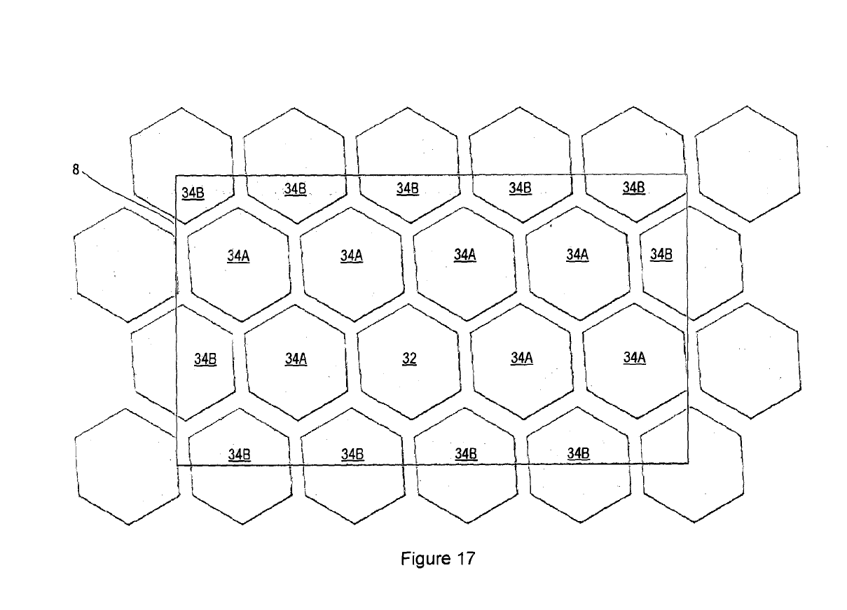

FIG. 16 is a cross-section through an antenna according to a sixth embodiment of the invention. This embodiment is an extension of the embodiment shown in FIG. 9 in which the elements 32, 34 can be spaced different distances from the ground plane 36 (with the difference in height from the ground plane 36 of the active element 32 and passive elements 34 being at). In FIG. 16, the active element 32 is positioned closer to the ground plane 36 than the passive elements 34, and the passive elements 34 are positioned so that they partially overlap with the active element 32 by an amount dₒᵥₑᵣₗₐₚ (when viewed from above or below the ground plane 36). In other words, given that the width of an element 32, 34 is approximately half the wavelength λ of the required electric field, the active and passive elements 32, 34 are arranged so that the distance between their geometric centre points is less than λ/2. This arrangement provides a larger area for coupling between the active element 32 and the passive elements 34 to occur. Preferably, each of Δt and dₒᵥₑᵣₗₐₚ are a small fraction (e.g. less than 10%) of the overall dimensions of the element 32, 34.

Although separate embodiments or implementations described above show that the field produced by an antenna 2 according to the invention can be configured by changing the spacing between passive elements 34 and the active element 32, changing the spacing between the elements 32, 34 and the ground plane 36, rotating one or more elements 32, 34 about their lattice points, offsetting elements 32, 34 from their lattice points, providing the elements 32, 34 with raised edge portions 39, arranging one or more of the elements 32, 34 so that they are not parallel to the ground plane 36, overlapping the active element 32 and one or more passive elements 34, or skewing regular polygons to produce turbulent field components; it will be appreciated that any combination of the above modifications can be applied to a generally regular array of elements 32, 34 in order to produce a useful EM field according to the invention that can read RFID tags. It will be appreciated from the above embodiments that the desired turbulent electric field is provided by an antenna 2 in which most or all of the lines of symmetry provided by a regular array of regularly shaped elements are broken, which removes the ‘pinning points’ of the electric fields produced by each element 32, 34.

In the above embodiments, the antenna 2 comprises a flat ground plane 36 with the elements 32, 34 arranged in one or more planes parallel to the ground plane 36. However, it will be appreciated that in some embodiments, the antenna 2 can be formed into a three-dimensional shape, such as a hemisphere or sphere, which can act as a multidirectional near- or far-field antenna.

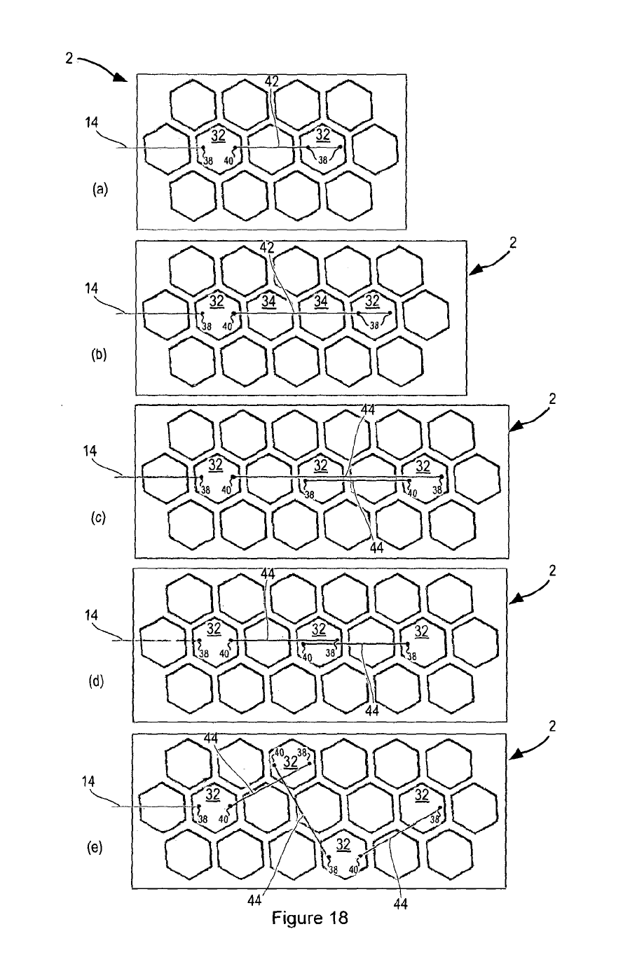

FIG. 17 shows how an antenna 2 according to the invention can be constructed to cover the whole of the work surface 8 of a desk 4 to extend the read volume 6 to cover the whole desk 4. In particular, a section of a larger antenna arrangement can be used to cover the required area 8. As above, elements are arranged in a lattice structure, and one of the elements is selected as the active element 32 (so the driving signal is supplied to this element through a feed point 38). The remaining elements within the area 8 act as passive elements 34 to the active element 32. Some of the passive elements, elements 34A, are complete elements, and some of the elements at the edge of the area 8 are partial elements, elements 34B. As indicated above in FIG. 12, coupling occurs to the partial passive elements 34B in generally the same way as to the complete or standard passive elements 34A and allows the field to extend generally to the edge of the required area 8. It will be appreciated that area 8 can be any desired shape, including square, rectangular, L-shaped or curved (including the surfaces of three-dimensional objects such as hemispheres and spheres).

For antennas 2 that are to cover a large area (i.e. where there might be a number of (complete or incomplete) patch elements of passive elements 34 to be arranged around an active element 32), it is desirable to have multiple active elements 32 in the antenna 2 to provide as uniform a field across the antenna 2 as possible. In this case, it is necessary to provide the driving signal to more than one active element 32 in the antenna 2.

In some embodiments, the driving signal can be split to multiple active elements 32 using power dividers. However, power dividers can be expensive, so it is preferable to use an alternative technique to split the power of the driving signal between the active elements 32.

In particular, in preferred embodiments of the invention, when multiple elements 32 are to be driven to produce the electric field, power is split between the elements 32 resonantly.

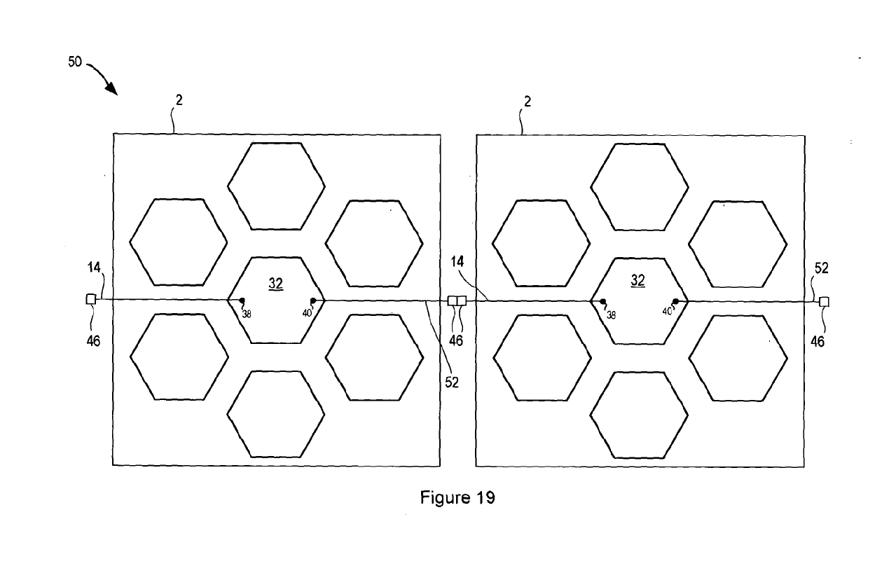

A first example of using resonant power splitting is shown in FIG. 18(a). In this example, the antenna 2 comprises a first active element 32 that can be connected to a reader unit 12 via electrical connection 14 at feed point 38, as in the embodiments above. It has been found that the electric fields in the first active element 32 at the opposite side of the element 32 to the feed point 38 are high, and therefore a second active element 32 can be driven by connecting a feed point 38 on the second active element 32 to a point that is 180° out of phase with the feed point 38 on the first active element 32. This point is termed a supply point 40, and an electrical connection 42 (which might be, for example, coaxial cable) is provided between the supply point 40 on the first active element 32 and the feed point 38 on the second active element 32. It has been found that there are generally no restrictions on the length of the electrical connection 42 used to connected the first and second active elements 32 to each other provided that the length of the cable is defined such that there is little interference between the driven elements, Although the antenna 2 shown in FIG. 19(a) and the other Figures discussed below comprise regular hexagons, the principle of resonant power splitting can be used in antennas 2 that comprise other polygons, regular or otherwise (e.g. skewed).

FIG. 18(b) shows a second example of resonant power splitting in an antenna 2. This example is similar to that shown in FIG. 18(a), although there are two passive elements 34 between the first and second active elements 32, rather than one as in FIG. 18(a). A separation of at least two passive elements 34 is preferred, as it provides a more uniform electric field.

FIGS. 18(c) and 18(d) show further examples of resonant power splitting in which power is split between three active elements 32. In these examples, a second active element 32 is connected to the first active element 32 in the same way as in the examples above, and the third active element 32 is driven through a respective feed point 38 from a supply point 40 on the second active element 32. In the example in FIG. 18(c), the third active element 32 is located between the first and second active elements 32, whereas in the example in FIG. 18(d), the first, second and third active elements 32 are arranged in a linear fashion across the antenna 2. As in the examples in FIGS. 18(a) and (b) above, the location of the feed point 38 on the second and third active elements 32 (i.e. left or right hand side) will depend on the direction of non linear polarisation required.

FIG. 18(e) shows an antenna 2 having four active elements 32. These elements 32 are interconnected in a similar way to the examples shown in FIGS. 18(a)-(d).

In an alternative embodiment of the invention, it is possible to connect multiple antennas 2 together using resonant power splitting to form an array 50 as shown in FIG. 19. In this case, each antenna 2 is provided in modular form with a feed line (electrical connection) 14 that is connected at one end to feed point 38 and at the other end to a connector 46, and a supply line (electrical connection) 52 that is connected at one end to supply point 40 and at the other to a connector 46. An array 50 can be formed by connecting the supply line 52 of one antenna 2 to the feed line 14 via connectors 46. When the feed line 14 of one of the antennas 2 is connected to a reader unit 16 and driven at the required frequency, power is split to the other antenna 2 resonantly, as in the examples above, to produce a single larger read volume 6 for the reader unit 16 (if the antennas 2 are spaced close enough for there to be coupling between their respective passive elements 34), or two separate read volumes 6 for the reader unit 16 (if the antennas 2 are spaced far enough apart for there to be negligible coupling between them). This embodiment of the invention therefore allows a large array to be constructed easily to cover the required area and increase the read volume 6.

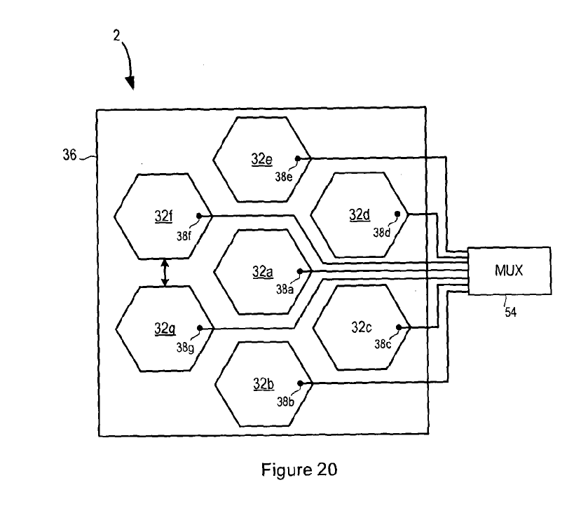

FIG. 20 shows an alternative way of driving an antenna 2 according to the invention to generate a turbulent rotating field in the read volume 6. In this embodiment, each of the elements (labelled 32a-32g in this embodiment) in the antenna 2 comprises a respective feed point (38a-38g respectively) that is connected to a multiplexer 54. The multiplexer 54 is configured to provide a driving signal to just one of the elements 32a-32g at any given point in time, which means that the driven element is the active element, and the remaining elements are passive elements to which power is coupled from the active element. The multiplexer 54 is configured to switch through each of the elements it is connected to in turn to change which element 32a-32g is the driven element, and thus generate a time-varying electric field above the antenna 2. Thus, at a first time instant, element 32a will be the driven element and the remaining elements 32b-g will be passive, then at a second time instant element 32b will be the element driven by the multiplexer 54 and elements 32a and 32c-g will be passive, etc. It will be appreciated that the driving technique shown in FIG. 20 can be used in any of the antennas 2 according to the above embodiments. Where the driving technique is applied to antennas 2 that are connected together to form an array 50 using resonant power splitting, each of elements 32a-g can be connected to a respective element in the next antenna 2.

In the description of the embodiments of the invention provided above, it is indicated that the antenna 2 can be placed on or below a work surface 8 of a desk 4. However, it will be appreciated that the antenna 2 can be integrated with the work surface 8, for example by arranging the antenna 2 so that work surface 8 is used as a dielectric material between the active and passive elements 32, 34 which are placed on the work surface 8, and the ground plane 36 which is placed below the work surface 8.

It has been found that placing objects or RFID tags directly on the elements 32, 34 of the antenna 2 can cause damage to the reader unit 10, so preferably the antenna 2 is enclosed in a housing, so that the side of the housing is spaced from the elements 32, 34. Objects can then be placed in direct contact with the housing without there being any risk of damaging the reader unit 10. It will be appreciated that the use of a housing can also improve the aesthetics of the antenna 2 to a user.

As a further variation to the embodiments of the invention provided above, it is possible to make use of Babinet's principle to form an antenna according to the invention using the inverse structure to that shown in the earlier Figures. In these implementations, the antenna 2 can be formed from a continuous sheet having apertures of the appropriate size and shape (e.g. skewed hexagons).

There are therefore provided improved antennas for use with RFID tag readers that allow RFID tags to be reliably read when there are a number of RFID tags in close proximity to each other.

Although various embodiments of the invention have been described in detail above and illustrated in the drawings, it will be appreciated that these embodiments are exemplary and are not intended to limit the invention. Those skilled in the art will be able to design many alternative embodiments without departing from the scope of the appended claims. The word “comprising” does not exclude the presence of components or steps other than those listed in a claim, “a” or “an” does not exclude a plurality, and a single feature or other unit may fulfil the functions of several units recited in the claims. Any reference numerals or labels in the claims shall not be construed so as to limit their scope.

1. An antenna for use in interrogating RFID tags in close proximity thereto, the antenna comprising:
an active element configured to resonate at or close to a frequency required to read an RFID tag, the active element comprising a feed point; and
a plurality of passive elements, each passive element being configured to resonate at or around a frequency corresponding to said frequency, the passive elements being arranged around the active element such that the passive elements electromagnetically couple to the active element when the active element is driven by a signal supplied through the feed point.

2. An antenna as claimed in claim 1, wherein each of the passive elements is spaced the same distance from the active element.

3. An antenna as claimed in claim 1, wherein at least one of the passive elements is spaced a different distance from the active element to the other passive elements.

4. An antenna as claimed in claim 3, wherein the spacing between a passive element and the active element is set based on the proximity of the passive element to the feed point on the active element.

5. An antenna as claimed in claim 1, wherein one or more of the active element and/or passive elements is positioned so that it is rotated about an axis that is perpendicular to the plane of the element relative to the other elements.

6. An antenna as claimed in claim 1, wherein the antenna further comprises a ground plane, and wherein the one or more of the active element and/or passive elements are spaced a different distance from the ground plane to the other elements.

7. An antenna as claimed in claim 6, wherein the active element is located closer to the ground plane than the plurality of passive elements, and wherein one or more of the plurality of passive elements overlap with a respective portion of the active element.

8. An antenna as claimed in claim 1, wherein the plane of one or more of the active element and/or passive elements is not parallel to the plane of the other elements.

9. An antenna as claimed in claim 1, wherein one or more of the active and passive elements are regular shapes or polygons.

10. An antenna as claimed in claim 1, wherein one or more of the active and passive elements are irregular shapes or polygons.

11. An antenna as claimed in claim 1, wherein one or more of the active and passive elements are asymmetric polygons.

12. An antenna as claimed in claim 11, wherein the asymmetric polygons are skewed polygons or other shapes, with the skew defined as a shifting of a first set of neighbouring vertices of a polygon relative to a second set of neighbouring vertices of the polygon.

13. An antenna as claimed in claim 1, wherein the active element and/or plurality of passive elements are hexagonal.

14. An antenna as claimed in claim 1, wherein the active element and the plurality of passive elements are arranged with respect to each other and/or configured such that there are no lines of symmetry in the antenna.

15. An antenna as claimed in claim 1, wherein the active element and plurality of passive elements are arranged substantially in the same plane.

16. An antenna as claimed in claim 1, wherein the active element and plurality of passive element are arranged on a three-dimensional surface to form a three-dimensional shape.

17. An antenna as claimed in claim 1, wherein one or more of the plurality of passive elements comprises a respective feed point, the antenna further comprising a multiplexer connected to each of the feed points, the multiplexer being configured to provide a signal to each of the feed points in turn.

18. An antenna as claimed in claim 1, the active element further comprising a supply point that is approximately 180° out of phase with the feed point on said active element, the supply point being for connection to the feed point of another active element.

19. An antenna as claimed in claim 18, further comprising a second active element configured to resonate at the frequency required to read an RFID tag, the second active element comprising a feed point; wherein the feed point on the second active element is connected to the supply point on the first active element such that the power of the signal supplied through the feed point of the first active element is divided between the first active element and the second active element.

20. An antenna array, comprising:
at least two antennas, each of the antennas being constituted by the antenna as claimed in claim 18, wherein the feed point on the active element of a first one of the antennas is connected to a supply point on the active element of a second one of the antennas such that the power of the signal supplied through the feed point of an active element in the second one of the antennas is divided between the first one of the antennas and the second one of the antennas.

21. (canceled)
